(19) United States
(12) Patent Application Publication
(10) Pub. No.: US 2007/0278800 A1
(43) Pub. Date: Dec. 6, 2007

(54) Linear generator

(76) Inventor: Thomas P. Galich, Laguna Hills, CA (US)

Correspondence Address: STETINA BRUNDA GARRED & BRUCKER, 75 ENTERPRISE, SUITE 250, ALISO VIEJO, CA, 92656, US

(21) Appl. No.: 11/445,619

(22) Filed: Jun. 2, 2006

(51) Int. Cl. H02K 7/18; F03G 7/08; F02B 63/04

(52) U.S. Cl. 290/1 R

(57) ABSTRACT

A linear generator which generates electric energy by reciprocal movement of magnets with inductive coils is provided. The linear generator has a plurality of elongate inductive coils, a plurality of magnets inserted into the respective inductive coils and slidable between two opposing ends of the inductive coils, a pulley assembly connected to top ends of the magnets, and an elevating motor generating and applying a lifting force to the magnets through the pulley assembly. The pulley assembly is operative to provide 1:N mechanical advantage, where N is preferably an even integer larger than 1. The pulley assembly is connected to the magnets by a plurality of rigid cables, rods, or strings, and a cable connected to the elevating motor is reeved through the pulley assembly, so as to exert a lifting force to the magnets via the pulleys.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates in general to an electrical energy generator, and more particularly, to a linear generator which generates either alternate (AC) or direct current (DC) electrical energy by the reciprocal movement of permanent magnets through inductive coils.

Currently, fossil fuels or hydrocarbons are the main source of fuel for electrical energy generation. As it is well known that these fuels are non-renewable and their supply can be ultimately exhausted. In addition to the limited supply, the burning of fossil fuels produces unwanted byproducts such as sulfur dioxide, carbon dioxide, and oxides of nitrogen. Scientists have proven that such byproducts are hazardous to the environment as well as to human health. Thus, in attempts to conserve the limited supply of non-renewable fossil fuels, alternative energy sources are being developed. However, none of the alternative energy sources has been commonly adapted because of their complexity and associated high costs. For example, solar power is a clean source of electricity essentially producing no pollutants. However, solar power electricity generation systems are typically very expensive to build and maintain. The large costs of solar power systems are therefore often prohibitive. Also, the effectiveness of solar power systems is highly dependent on the availability of sunlight and thus is a feasible source of energy only in locations having a compatible climate.

Geothermal energy is a relatively clean and low cost source of energy that has been in production for quite some time. Technology has been undergoing continuous development in order to more effectively exploit geothermal energy such that it is more economical and efficient in the production of electricity. The main drawback to geothermal energy is that it is dependent upon geographical location and, thus, it is not readily available throughout the world. Hydroelectric power plants produce energy by harnessing the power of rivers and other waterways. Although many hydroelectric power plants have been built throughout all parts of the world, this type of energy production unfortunately has significant detrimental environmental impacts. Construction of new dams and power generating facilities face prohibitively complex and costly governmental regulations with the recent effect of a curtailment in the building of hydroelectric power plants.

Energy producers also use windmills and other wind-powered devices to harness the power of the wind. Interest in generating electricity using the power of the wind recently reaches its peak. However, it is still not a significant source of energy, mainly because of the inconsistency of the wind and the need to store the electricity produced therefrom until there is a sufficient demand. On top of the efficiency and storage issues, a recent study conducted by BioResource Consultants for the national Energy Lab has found that certain types of windmills kill birds at a rate five times higher than previously estimated. The eye-sore structures and the bird killing facts have provoked serious disputes between the windmill operators and the environmentalists. In addition to the above-mentioned sources of alternative energy, nuclear power is also use for the generation of electricity. As it is well known that nuclear power generation results in radioactive nuclear waste as a byproduct. The disposal of such byproducts has proven to be controversial and expensive.

Currently, the government offers many incentives for utilizing efficient energy equipment based on proven energy cost savings subject to meeting certain minimum energy efficiency requirements. For example, rebates are offered by the government to help offset the cost of new high-efficiency equipment. In addition, the government offers cash rebates on development of environmentally friendly electric generating equipment, including microturbines and internal combustion generators.

Thus, there exists a need in the art for an electricity generation system that is configured to produce energy in a clean and efficient manner and yet does not further deplete the diminishing source of hydrocarbon-based fuels.

### BRIEF SUMMARY

A linear generator which generates electric energy by reciprocal movement of a plurality of magnets through inductive coils is provided. The linear generator includes a plurality of elongate inductive coils, a plurality of magnets to slide between two opposing ends of the inductive coils, a pulley assembly connected to one end of each magnet, and an elevating motor generating a lifting force to the magnets through the pulley assembly. The pulley assembly is operative to provide 1:N mechanical advantage, where N is preferably an even integer larger than 1. Therefore, the power capacity as generated is N times of the power required for driving the linear generator. The linear generator further comprises a plurality of rigid cables, rods, or strings connecting the magnets to the pulley assembly, and a cable to connect the pulley assembly to the elevating motor via a cable.

In one embodiment, the linear generator is supported by a frame or housing which includes a vertical sidewall encircling the conductive coils and a laterally extending beam or plate fitted between the pulley assembly and the magnets and the inductive coils. The laterally extending beam includes a plurality of openings allowing the rigid cables connecting the pulley assembly with the magnets to extend and retract through. The top end of each rigid cable is preferably in the form of a laterally expansion with a cross section larger than the corresponding opening. To reduce the shock generated when the magnets reach the bottom of the inductive coils by gravity thereof, a top portion of each rigid cable is configured with a tapered cross sectional. A shock-absorbing counterweight may also be installed at the bottom of each inductive coil to further reduce the shock. The shock-absorbing spring may also serve as a recoiling device which exerting resilient force to the magnets so as to push the magnets moving upwardly against gravity. Thereby, the lifting force by the motor can be reduced in addition to the mechanical advantage provided by the pulley assembly. In addition, a gas spring may also be installed for each set of inductive coil and magnet to not only reduce the shock caused by the downward movement of the magnets, but also help lift the magnets, such that less power will be required by the motor.

Although a vertical arrangement of the elongate inductive coils is preferred, the elongate inductive coils may also extend with an angle inclined from the vertical orientation. In one embodiment, each of the magnets may comprise a pair of guiding posts laterally extending from two opposing sidewalls thereof. The distal ends of the guiding posts are preferably terminated with rollers, such that the friction cause by the contact between the guiding posts and the inductive coils can be reduced. To accommodate the guiding posts or the rollers, the inductive coils is configured with a pair of guiding channels extending through the length thereof. The frame or the housing of the linear generator is preferably laminated with thin lead sheeting to suppress electromagnetic fields which are found whenever electric power is present.

In one embodiment, the elevating motor may be controlled by a motor controller. The motor controller includes a lower limit switch and an upper limit switch. When the magnets reach the bottom of the inductive coils, the lower limit switch is operative to activate the elevating motor, so as to drive the magnets moving upwardly against the gravity. In contrast, when the magnets reach the top portion of the inductive coils, the upper limit switch is operative to inactivate the elevating motor, such that gravity becomes the only force applied to the magnets. The magnets can thus move downwardly again. The reciprocal movements of the magnets within the inductive coils thus generate AC power.

In another embodiment, a linear generator comprising multiple sets of magnets and inductive coils, a plurality of pulleys, and an elevating device is provided. Each set of magnets and inductive coils includes an inductive coil and a permanent magnet sliding between two opposing ends of the inductive coil. The magnets are operative to move downwardly within the inductive coils by gravity and driven by the elevating device to move upwardly against gravity. The elevating device includes a plurality of springs located at bottoms of the inductive coils and/or a motor driven by various energy sources, including solar cell energy, mechanical energy, AC electricity or a batter.

The linear generator may includes a plurality of sets of inductive coils and permanent magnets arranged side by side in a single row or as an array that includes multiple rows or layers each comprising a plurality sets of inductive coils and permanent magnets. To save the space or area, the inductive coils and the permanent magnets can also be arranged along a cylindrical profile. The arrangement flexibility allows the linear generator to be configured in a wide range of sizes adapted for powering a wide range of inhabitable structures including residences, commercial facilities, factories and vehicles. For example, the linear generator can be installed in a vehicle such as a car or a truck, such that the vehicle can be operated by electric power instead of fuel. While applying in a factory or a power plant where large power is often required, multiple rows or layers of inductive coils and permanent magnets can be ganged together to provide the desired output.

In an alternate embodiment, the pulley assembly can be replaced by a power pneumatic device; and instead of lifting the magnets directly, the power pneumatic device is operative to drive the inductive coil about its center like a titter-totter, such that the magnets can move between two opposing ends inside of the inductive coil to generate AC or DC electricity. The power pneumatic device includes a rigid rod telescoped with a cylinder, which is pivotally supported by a base. The rigid rod is connected to at least one end of the inductive coil and driven by a compressor to move between a fully extended position and a fully retracted position. The pivotal connection between the cylinder and the base allows the rigid rod to pivot in response to the lateral displacement caused by the swing motion of the inductive coil.

The titter-totter like linear generator as discussed above can be modified by using a pair of motors to apply a pulling force to the opposing ends of the inductive coil. Again, with very limited power source provided by the motors, significant amount output electric power can be generated by the reciprocal movement of the magnet within the inductive coil. Similarly, multiple inductive coils and motors can be ganged together to multiply the overall power output.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a linear generator as provided in one preferred embodiment;

FIG. 2 shows the shock suppression configuration of the top portions of the rigid cables;

FIG. 3 illustrates an exemplary structure of the pulley assembly;

FIG. 4 shows the guiding structure of the magnets;

FIG. 5 is a top view of a set of inductive coil and magnet;

FIG. 6 shows a modification of the linear generator as shown in FIG. 1;

FIG. 7 shows the application of the linear generator in a vehicle;

FIG. 8 shows a modification of the linear generator as shown in FIG. 1;

FIG. 9 shows a linear generator that combines multiple linear generators as shown in FIG. 8; and

FIG. 10 shows a modification of the linear generator as shown in FIG. 8.

### DETAILED DESCRIPTION

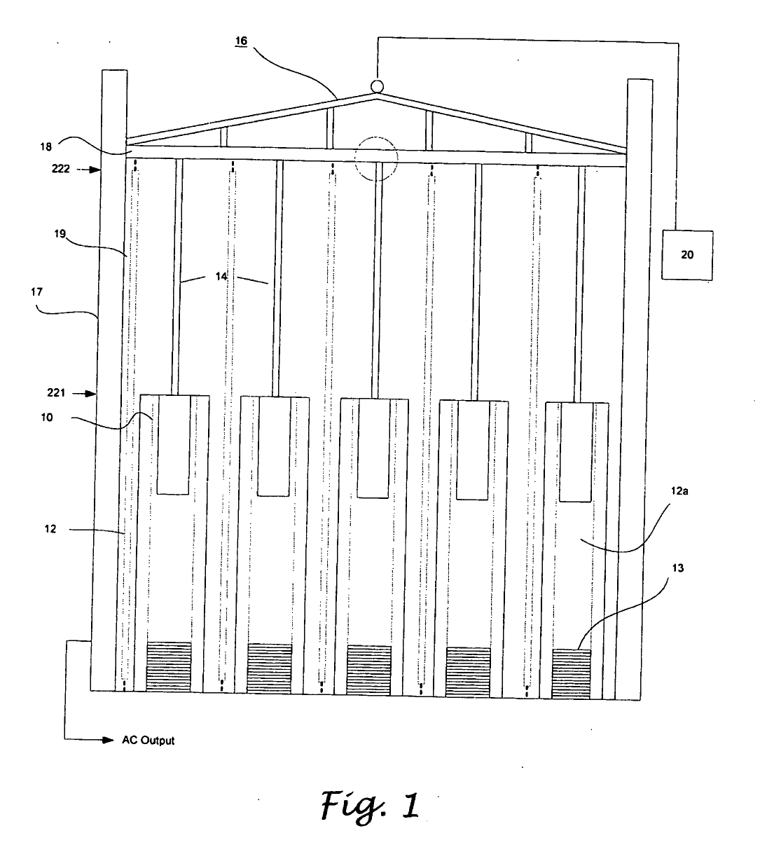

A linear generator producing AC or DC electric energy by reciprocally movement of magnets between two opposing ends of induction coils is provided and illustrated in FIG. 1. As shown, the linear generator includes a plurality of inductive coils 12 and a plurality of magnets 10 supported and enclosed by a frame or housing (17 and 18), an electric motor 20 for generating a lifting force to the magnets 10, and a pulley assembly 16 connecting the magnets 10 to the electric motor 20 and providing a mechanical advantages. Each of the conductive coils 12 defines a channel 12a allowing the magnets 10 to move through in either direction. The top end of each magnet 10 is connected to the pulley assembly 16 via a rigid rod, string, or cable 14. When the magnets 10 are located at the top portion of the channels 12a, the gravity drives the magnets 10 moving downwardly through the channels 12a. When the magnets 10 reach the bottom portion of the channels 12a, the pulley electric motor 20 generates a force to pull the rigid cables 14 via the pulley assembly 16, such that the magnets 10 are forced to move upwardly against the gravity. Preferably, a counter-weight or gas spring 13 is installed at the bottom portion of each channel 12a to serve as shock absorber of the magnets 10. In application, as the continuous reciprocating movement of the magnets 10 is desired for generating the AC or DC output, the resilient force exerted by the counter-weight spring 13 may assist the upward movement of the magnets 10, such that the lifting force required to lift the magnets 10 to the top of the channels 12a can be lessened; and consequently, the power to be generated by the electric motor 20 can be reduced.

According to Faraday's Law, any change in the magnetic environment of a coil of wire will cause a voltage (emf) to be “induced” in the coil. In the embodiment as shown in FIG. 1, every time when each magnet 10 moves from one end of the channel to the other, a voltage is generated as:

V=−N(ΔΦ/Δt),

where N is the number of turns for the corresponding inductive coil 12, Φ is the magnetic flux equal to the multiplication of the magnetic field B and the cross-sectional area of the inductive coil A. Therefore, in the embodiment as shown in FIG. 1, the total output voltage will be 5 V when five sets of inductive coils 12 and magnets 10 are incorporated, provided that the number of turns N and cross-sectional area A of the inductive coils 12 and the magnetic field generated by the magnets 10 are the same. It will be the number of the inductive coils and magnets, and the turns and magnets as selected may be greatly varies according to the specific application.

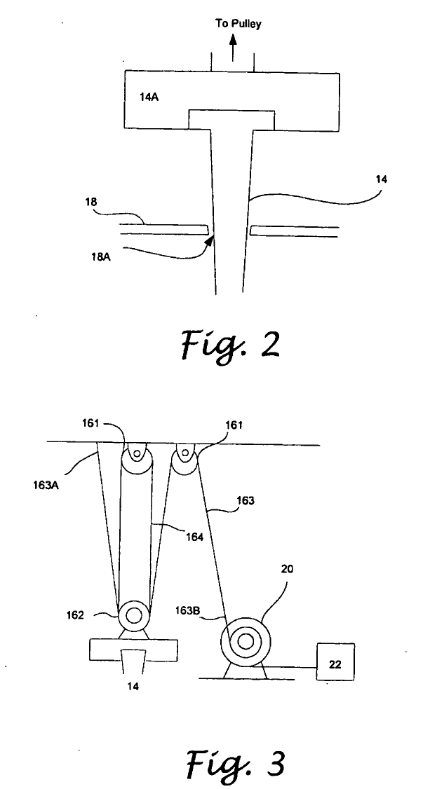

The housing includes a vertical sidewall 17 and a horizontal beam or plate 18 to enclose the conductive coils 12 and the magnets 10 therein. In consideration of electromagnetic interference and compatibility issues, the housing 17 and 18 may be covered with thin lead sheeting. As shown in FIG. 2, the horizontal beam 18 includes a plurality of openings 18a allowing the rigid cas 14 to extend through. To further reduce the shock caused by the downward movement of the magnets, in addition to the counter-weight spring 13, a clutch (circled portion in FIG. 1) may also be installed at the horizontal beam 18 where the cable 14 is connected to the pulley assembly 16. FIG. 2 shows an exemplary structure of the clutch. As shown in FIGS. 1 and 2, being driven by the gravity of the magnets 10 and the electric motor 20, the rigid cables 14 extends through the openings 18A of the horizontal beam or plate 18. In this embodiment, the clutch includes an expansion 14A at the top end of each rigid cable 14A. The expansion 14A has a cross-sectional area larger than the openings 18A to serve as a limiting or stopping mechanism which avoid further extension of the cables 14 through the openings 18A. In addition, the top portion of each rigid cable 14 is configured with a tapered cross section, that is, a gradually increasing cross section up to the expansion 14A. Therefore, the downward speed of magnets 10 driven by gravitation can be reduced while reaching the bottoms of the channels 12a to eliminate mechanical wear or crash.

As shown in FIG. 1, each set of the permanent magnet 10 and the inductive coil 12 may also includes a gas spring 19 to provide less downward stroke and decrease the upward stroke time. The length of the gas spring 19 is preferably the distance which the magnets 10 are allowed to move.

FIG. 3 illustrates an exemplary pulley system 16 that can be used to lift the magnets 10 against the gravitation. As shown, for each magnet 10, the pulley assembly 16 includes a pair of independently rotating support frame pulley 161, an independently rotating pulley 162, and a coupling line 163 fabricated from rope or cable. The support frame pulleys 161 are rotatably mounted on a top wall or support structure. The pulley 162 is rotatably connected to the top end of the expansion 14A of the cables 14. The coupling line 163 has a first end 163A fitted to the top wall and a second end 163B attached to the upper portion of the enclosure and the elevating motor 20, respectively. Preferably, the elevating motor 20 is further connected to a motor controller 22 for controlling the elevation force exerted thereby. The coupling line 163 is also reeved through the pulley 162 and the support frame pulleys 161. The pulley assembly 16 as shown in FIG. 3 is substantially vertically oriented and provides a mechanical advantage of about 4:1 since the mass of the magnets 10 is equally supported by the respective sections of the coupling line 163 reeving through the pulleys 161 and 162. With such arrangement, the force required for lifting the magnets 10 is only ¼ of the weight thereof. As discussed above, the installation of the springs 13 at the bottoms of the channels further reduced the required lifting force generated by the electric motor 20. Therefore, with very small amount of electricity force, more electricity can be generated by the relative movement of the magnets 10 to the inductive coils 12.

As illustrated in FIG. 3, the elevating motor 20 may be electrically connected to the motor controller 22 via an electrical line. In the embodiment as shown in FIG. 1, the motor controller 20 may comprise an upper limit switch 221 and a lower limit switch 222 mounted to the vertical sidewall 17 of the housing or frame to activate and inactivate the electric motor 20 in accordance with the position of the magnets 10, so as to provide the upper and lower limits of the lifting movements of the magnets 10. For example, when the magnets 10 approach the bottom of the channels 12a, the lower limit switch 222 is switched to the position to activate the elevating motor 20, such that the electric motor 20 is operating to generate the lifting force allowing the cables 14 to lift magnets 10 upwardly until approaching the top portion of the channels 12a. At the time the magnets 10 approach the top portion of the channels 12a, the upper limit switch 221 is switched to the position to inactivate the elevating motor 221. Once the lifting force generated by the elevating motor 221 is released, the gravity of the magnets 10, again, driving the magnets 10 to move downwardly to generate electromagnetic force in another direction. Thereby, AC electricity is generated.

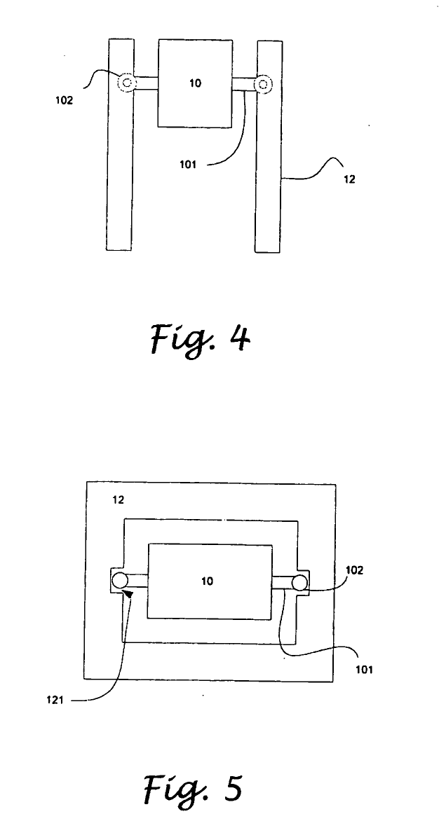

The linear generator as shown in FIG. 1 has a substantially vertical arrangement. It will be appreciated that the inductive coils 12, the movements of the magnets 10 can also be inclined with a predetermined angle as desired. The inclined reciprocal motion of the magnets 10 does not only reduce the shock created when the magnets 10, but also reduces the force required to lift the magnets 10 from the bottom to the top of the channels. However, to provide a more smooth movement of the magnets 10 within the channels 12a of the inductive coils 12, as shown in FIG. 4, a pair of guiding posts 101 may be formed to laterally extend between the opposing sidewalls of each magnet 10 and the interior sidewall of the inductive coils 12. The distal ends of the guiding posts 101 are preferably terminated with rollers 102 to provide smooth movement of the magnets 10. To accommodate the distal ends of the guiding posts 101, the inductive coils 12 are preferably configured to form a pair of guiding channels 121 extending along a length of thereof. FIG. 5 is a top view of a set of an inductive coil and a magnet incorporating the guiding posts 101 and the guiding channels 121, respectively. Although the inductive coil 12 and the magnet 10 as shown in FIG. 5 have a rectangular cross section, it will be appreciated that various shapes such as circular, polygonal, square, trapezium, and any irregular shapes may also be used according to specific requirement. The guiding posts 101, rollers 102 and the guiding channels 121 are particularly useful for the inclined generator as shown in FIG. 4.

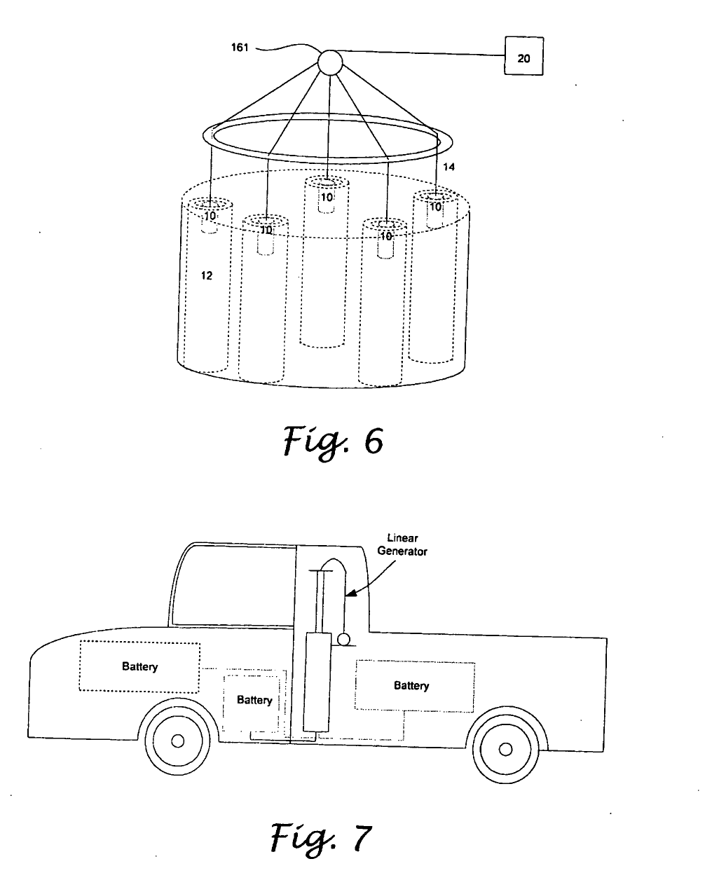

In the linear generator as shown in FIG. 1, the sets of conductive coils 12 and the permanent magnets 10 are arranged side by side in a single row. It will be appreciated that the arrangement of the conductive coils 12 and the permanent magnets 10 can be modified according to specific requirement. For example, the linear generator may include an array, that is, a plurality of rows of sets of inductive coils 12 and permanent magnets 10. Alternatively, the linear generator may be configured with a cylindrical profile by arranging the inductive coils 12 and the permanent magnets 10 as shown in FIG. 6, in which the top ends of the rigid cables 14 are reeved with a central support frame pulley, through which the magnets 10 are lifted by the motor 20.

As discussed above, the linear generator can be configured with a wide range of sizes and structures adapted for powering a wide range of inhabitable structures such as residences, commercial facilities, factories, power plants, and vehicles. FIG. 7 illustrates the application of the linear generator in a vehicle such as an automotive car or truck. As shown, the linear generator may be fitted within the vehicle and the output of the linear generator is connected to a battery for storing the electric energy generated thereby to the vehicle. According to the specific structure of vehicle, the batter may be installed in various locations of the vehicle.

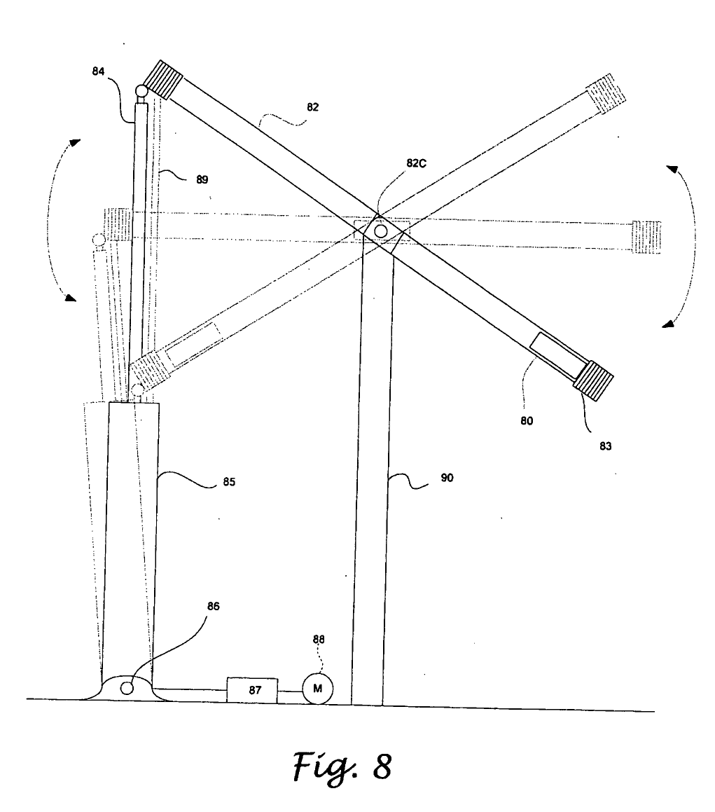

FIG. 8 provides a side view of a linear generator which includes at least one inductive coil 82 and a magnet 80 slidable within the inductive coil 82. Instead of driving the movement of the magnet 80 by a motor, in this embodiment, a hydraulic or power pneumatic device is used to reciprocally push up and pull down a proximal end of the inductive coil 82, such that the inductive coil 82 can swing about its central pivot point 82C. As the inductive coil 82 is swinging about the central pivot point 82C like a titter-totter, the gravitation drives the magnet 80 to move between the proximal end and the distal end within the inductive coil 82. The movement of the magnet 80 through the inductive coil 82 generates an AC electric voltage. Preferably but optionally, a shock absorption coil or cushion soft material 83 is installed at the proximal end and the distal end of the inductive coil 82. As shown in FIG. 8, the linear generator further includes a support stand or frame 800 to pivotally support the central pivot point 83 of the inductive coil 82.

The hydraulic or power pneumatic device includes a rigid rod 85 telescoped with a cylinder 85 and connected to the proximal end of the inductive coil 82, a base 86 pivotally supporting the cylinder 85, a compressor or pump 87 to drive the rigid rod 84 to the extended or retracted position, and an electric motor 88 to drive the compressor 86. When the rigid rod 84 is driven to the fully extended position as illustrated by the solid line in FIG. 8, the magnet 80 moves to the distal end of the inductive coil 82. When the rigid rod 84 is driven from its fully extended position towards the fully retracted position, that is, the position where the rigid rod 84 is substantially completely telescoped within the cylinder 85, the magnet 80 moves from the distal end to the proximal end as shown by the dash line. When the inductive coil 82 swings to a horizontal position, the pivotal connection between the cylinder 85 and the base 86 allows the rigid rod 84 and the cylinder 85 to incline with the distal end, so as to ensure a smooth swing motion of the inductive coil 82.

By adequately selecting the material of the magnet 80 and the coil number of the inductive coil 83, the power required by the electric motor 88 is only a fraction of the AC electric generated by the reciprocal movement of the magnet 80 within the inductive coil. In certain specific condition when the value of power required to drive the compressor 86 exceeds the amount of electricity generated by the generator, a gas spring 88 may be used to reduce the power as required by the motor 88.

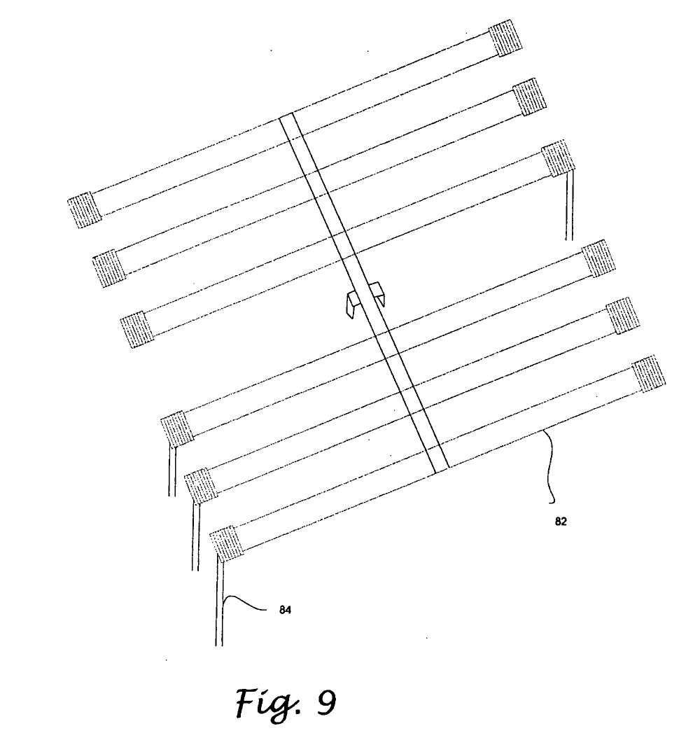

Although only one set of magnet 80 and inductive coil 82 is illustrated in FIG. 8, for application that requires larger output, it will be appreciated that the linear generator may includes a plurality of sets of swinging inductive coil 82 and magnets 80 connected together for high power generation. FIG. 9 shows an exemplary configuration of the linear generation which connects multiple sets of inductive coils, magnets and power pneumatic devices. In the embodiment as shown in FIG. 9, the power pneumatic device for each inductive coil may be mounted at either or both ends thereof. In addition, the power pneumatic devices may be driven respective motors or the same motor.

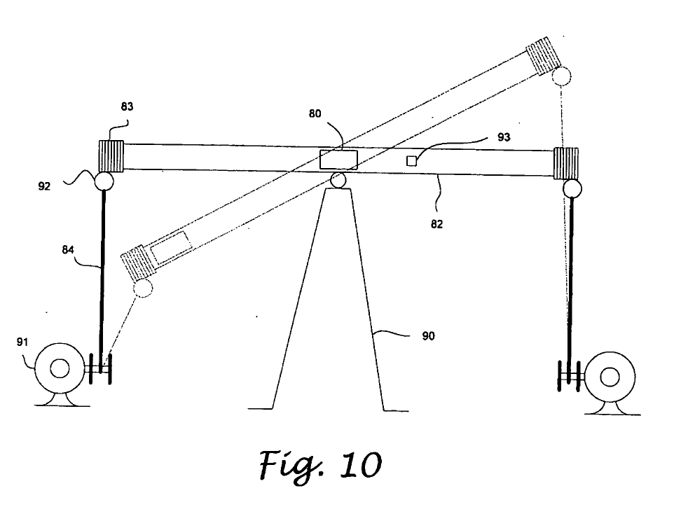

The power pneumatic device as shown in FIGS. 8 and 9 may be replaced by a pair of motors alternately pulling the opposing ends of the inductive coil, such that the inductive coil can be driven to swing about its center in a titter-totter manner. FIG. 10 shows the linear generator using two motors at two opposing ends of the inductive coil. As shown, the linear generator includes a magnet 80 slideably disposed within an inductive coil 82. The inductive coil 82 has a center pivotally supported by a stand or a control console 90 and two free opposing ends. Preferably, two shock absorbing elements 83 are mounted to the opposing ends of the inductive coil 82 to suppress the impact caused by the movement of the magnet 80. Each end of the inductive coil 82 is connected to a motor 91 by a cable 84, and a wheel 92 may be mounted at the ends of the inductive coil 82 to provide a smooth swing motion of the inductive coil 82. The wheel 92 can be replaced by the pulley assembly as shown in FIGS. 1-3 to provide additional mechanical advantages. Once one end of the motor 91 is activated, a force is generated to pull the corresponding end of the inductive coil 82 downwardly, such that the magnet 80 will slide towards this corresponding end to generate electricity. A limit switch 93 is preferably installed in the inductive coil 80 to detect the swing angle of the inductive coil 82 or the height of the point on which the limit switch 93 is installed. When the swing angle reaches a predetermined limit or when the specific point reaches a specific height as illustrated by the dotted line in FIG. 10, the limit switch 93 is operative to stop or inactive the motor 91 at the left and initiate or activate the motor 91 at the right, such that the inductive coil 82 will be driven to swing counterclockwise until reaching the predetermined angle or height limit at the opposite side. Thereby, each motor pulley reels freely for upstroke cycles and for downstroke cycles employs a centrifugal clutch to grab the motor shaft. Similar to the embodiment as shown in FIG. 8, the output power generated by the movement of the magnet 80 within the inductive coil 82 is expected to be much larger than the power required for driving the inductive coil 82, particularly when the pulley assembly is applied. Therefore, with very limited power consumption, a larger power can be provided by the linear generator. Further, a plurality of the linear generators as shown in FIG. 10 can be ganged for the application that requires larger power output.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A linear generator, comprising:
a plurality of elongate inductive coils;
a plurality of magnets inserted into the respective inductive coils and slidable between two opposing ends of the inductive coils;
an elevating motor for generating a force to lift the magnets against gravity thereof; and
a pulley assembly connecting the elevating motor to the magnets, wherein the pulley assembly provides a 1:N mechanical advantage such that the force required to lift the magnets is only 1/N of the gravity of the magnets, where N is larger than one.

2. The linear generator as claimed in claim 1, wherein the N is an even integer.

3. The linear generator as claimed in claim 1, further comprising a plurality of rigid cables, rods, or strings connecting the magnets to the pulley assembly.

4. The linear generator as claimed in claim 3, further comprising a housing enclosing the inductive coils and the magnets.

5. The linear generator as claimed in claim 4, wherein the housing is fabricated from an electromagnetic interference and compatibility proof material.

6. The linear generator as claimed in claim 5, wherein the material includes lead.

7. The linear generator as claimed in claim 4, wherein the housing includes a vertical sidewall and a horizontal beam laterally extending between the pulley assembly and the magnets.

8. The linear generator as claimed in claim 7, wherein the horizontal beam includes a plurality of openings allowing the rigid cables to extend through between the pulley assembly and the magnets.

9. The linear generator as claimed in claim 8, wherein a top end of each rigid cable includes an expansion having a cross section larger than the corresponding opening.

10. The linear generator as claimed in claim 9, wherein a top portion of each rigid cable is tapered with a gradually widening cross sectional towards the expansion.

11. The linear generator as claimed in claim 1, wherein the elongate inductive coils are substantially vertically arranged.

12. The linear generator as claimed in claim 1, wherein the elongate inductive coils are arranged side by side in a row.

13. The linear generator as claimed in claim 1, wherein the elongate inductive coils are arranged in an array which includes a plurality of rows.

14. The linear generator as claimed in claim 1, wherein the elongate inductive coils are arranged with a cylindrical configuration.

15. The linear generator as claimed in claim 1, wherein each of the magnets further comprises a pair of guiding posts laterally extending between two opposing sidewalls the magnets and the an interior sidewall of the corresponding inductive coil.

16. The linear generator as claimed in claim 15, wherein each of the guiding posts is terminated with a roller.

17. The linear generator as claimed in claim 15, wherein each of the inductive coils is configured with a pair of guiding channels for accommodating distal ends of the guiding posts to slide through a length thereof.

18. The linear generator as claimed in claim 1, further comprising a plurality of counterweights or gas springs installed at a bottom portion inside each inductive coil.

19. The linear generator as claimed in claim 1, further comprising a motor controller operative to activate and inactivate the elevating motor.

20. The linear generator as claimed in claim 19, wherein the motor controller includes an upper limit switch for inactivating the elevating motor when the magnets reach the top portions of the inductive coils and a lower limits switch for activating the elevating motor when the magnets reach the bottom portions of the inductive coils.

21. A linear generator, comprising:
at least one inductive coil operative to swing about a center thereof;
a permanent magnet disposed within the inductive coil, the permanent magnet being slideable between two opposing ends of the inductive coil;
at least one power pneumatic device connected to one end of the inductive coil to drive the inductive coil swinging about the center thereof.

22. The linear generator as claimed in claim 21, further comprising one shock absorption device mounted at each end of the inductive coil.

23. The linear generators as claimed in claim 21, comprising a plurality of inductive coils each comprising one permanent magnet sliding therein.

24. The linear generator as claimed in claim 21, wherein the power pneumatic device further comprises:
a rigid rod having an open end connected to the end of the inductive coil;
a cylinder telescoping the rigid rod;
a base pivotally supporting the cylinder;
a compressor to drive the rigid rod to move between a fully extended position and a fully retracted position; and
a motor for driving the compressor.

25. The linear generator as claimed in claim 21, wherein the motor driven by solar cell energy, mechanical energy, AC electricity or a batter.

26. The linear generator as claimed in claim 21, further comprising a gas spring for reducing power required to drive the swinging motion of the inductive coil.

27. A linear generator, comprising:
at least one inductive coil operative having a center pivotally supported by a stand and two free opposing ends;
a permanent magnet disposed within the inductive coil, the permanent magnet being slideable between two opposing ends of the inductive coil;
a pair of motors connected to the free opposing ends of the inductive coil.

28. The linear generator as claimed in claim 27, wherein each of the motors is connected to the corresponding end of the inductive coil through a pulley.

29. The linear generator as claimed in claim 27, further comprising a limit switch activate one of the motor and inactivate the other motor when the inductive coil swings to a predetermined limit.

30. The linear generator as claimed in claim 27, further comprising a pair of pulley assemblies for connecting the motors to the ends of the inductive coil.

31. The linear generator as claimed in claim 30, wherein each pulley assembly provides a mechanical advantages of 1:N, where N is larger than 1.
